(19) United States
(12) Patent Application Publication
(10) Pub. No.: US 2019/0369555 A1
(43) Pub. Date: Dec. 5, 2019

(54) HOLOGRAPHIC USER INTERFACE FOR MOBILE MENU ITEM SELECTION

(71) Applicant: INTERNATIONAL BUSINESS MACHINES CORPORATION, Armonk, NY (US)

(72) Inventors: Sarbajit K. Rakshit, Kolkata (IN); Martin G. Keen, Cary, NC (US); John M. Ganci, JR., Cary, NC (US); James E. Bostick, Cedar Park, TX (US)

(21) Appl. No.: 15/996,634

(22) Filed: Jun. 4, 2018

(51) Int. Cl. G03H 1/00; G03H 1/04; G06F 1/16; G06F 3/0488; G03H 1/22

(52) U.S. Cl. CPC G03H 1/0005; G03H 1/0406; G06F 1/1647; G03H 2001/0038; G03H 1/2249; G03H 2227/02; G03H 2001/0061; G06F 3/04883

(57) ABSTRACT

A method, system, and computer program product for holographically displaying and navigating data content of a mobile device is provided. The method may include retrieving data content comprising an arrangement of data objects, wherein a size of the data content exceeds a predetermined threshold. Visualized data content may be generated based on the data content. The visualized data content is rendered for display by holographic projection with respect to on-screen data content, displayed by a touchscreen of the mobile device.

### BACKGROUND

The present invention relates generally to the field of user interfacing, and in particular to holographic display interfacing via motion sensing.

Certain computing platforms including mobile devices such as smartphones, smart watches, tablets, and other types of handheld or wearable computers (“mobile devices”), are increasingly miniaturized to facilitate transport and carry by end-users. The mobile devices may include user interfaces such as touchscreen devices (“touchscreens”), for displaying interactive information, media, and content (“data content”). A mobile device may include a touchscreen having a screen or display sized according to the size of the mobile device.

### SUMMARY

According to an aspect of the present invention, a computer-implemented method, computer system, and computer program product for holographically displaying and navigating data content of a mobile device is provided. The method may include retrieving data content comprising an arrangement of data objects, wherein a size of the data content exceeds a predetermined threshold. Visualized data content may be generated based on the data content. The visualized data content is rendered for display by holographic projection with respect to on-screen data content, displayed by a touchscreen of the mobile device.

### BRIEF DESCRIPTION OF THE DRAWINGS

FIG. 1 is a functional block diagram depicting a data content display system, in accordance with an embodiment of the present invention.

FIG. 2A is a flowchart depicting operational steps of an aspect of the data content display system, in accordance with an embodiment of the present invention.

FIG. 2B is a flowchart depicting operational steps of an aspect of the data content display system, in accordance with an embodiment of the present invention.

FIG. 3A is a flowchart depicting operational steps of an aspect of the data content display system, in accordance with an embodiment of the present invention.

FIG. 3B is a flowchart depicting operational steps of an aspect of the data content display system, in accordance with an embodiment of the present invention.

FIG. 4 is a block diagram depicting a digital distribution platform and/or a mobile device, in accordance with an embodiment of the present invention.

FIG. 5 depicts a cloud computing environment, in accordance with an embodiment of the present invention.

FIG. 6 depicts abstraction model layers, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the present invention are disclosed herein for purposes of describing and illustrating claimed structures and methods that may be embodied in various forms, and are not intended to be exhaustive in any way, or limited to the disclosed embodiments. Many modifications and variations will be apparent to those of ordinary skill in the art without departing from the scope and spirit of the disclosed embodiments. The terminology used herein was chosen to best explain the principles of the one or more embodiments, practical applications, or technical improvements over current technologies, or to enable those of ordinary skill in the art to understand the embodiments disclosed herein. As described, details of well-known features and techniques may be omitted to avoid unnecessarily obscuring the embodiments of the present invention.

References in the specification to “one embodiment,” “an embodiment,” “an example embodiment,” or the like, indicate that the embodiment described may include one or more particular features, structures, or characteristics, but it shall be understood that such particular features, structures, or characteristics may or may not be common to each and every disclosed embodiment of the present invention herein. Moreover, such phrases do not necessarily refer to any one particular embodiment per se. As such, when one or more particular features, structures, or characteristics is described in connection with an embodiment, it is submitted that it is within the knowledge of those skilled in the art to affect such one or more features, structures, or characteristics in connection with other embodiments, where applicable, whether or not explicitly described.

A touchscreen is a composite user interface device including an input/output (“I/O”) device layered on an electronic visual display of an information processing system such as a mobile device. The mobile device may implement the touchscreen to display data content. An end-user may control the display of the data content for viewing by way of the touchscreen, such as by providing user inputs to the touchscreen including simple or multi-touch gestures. The gestures may include, for example, swipes and taps that may be applied by touching the touchscreen with a special stylus or one or more fingers, such as to control the display to scroll through individual items or portions of the data content for viewing, selection, and the like.

An amount of displayable data content of the mobile device may be limited to the amount displayable (i.e., the amount that will fit) on-screen by the touchscreen. The amount of data content displayable on-screen by the touchscreen may be limited by a size of the touchscreen. The amount of displayable data content of the mobile device may be reduced with increasing miniaturization or reduction in size of the mobile device and the touchscreen.

Reducing an amount of displayable data content of a mobile device may reduce the ergonomics and usability of the mobile device with respect to certain types of data content, by limiting viewability of the data content on the mobile device. In particular, such as for data content including a list, menu, table, or arrangement of end-user selectable items, only a portion of the items may be displayable on-screen at any one time, with the rest of the items existing off-screen. This may cause the viewable data content to become segmented and require more effort from an end-user for complete viewing of the data content, such as by necessitating user inputs (e.g., gestures) for swiping and scrolling through the data content such as to view the off-screen items for evaluation, consideration, and selection. Such segmentation and an amount of the necessitated user inputs may be exacerbated by increased amounts of the data content. As such, the reduced amount of displayable data content caused by a touchscreen of reduced size may cause difficulties in navigating the data content and thereby reduce the ergonomics and usability of the mobile device. For purposes of the present disclosure, “display instance” may reference a display of data content of a mobile device during a time period.

For example, a mobile device may receive data content from a photo- and video-sharing application, such as for display by way of an associated touchscreen of the mobile device. The received data content may include, for example, a list, menu, table, or arrangement of end-user selectable items such as image filters that may be applied to an image as such may be obtained by an image capture device (e.g., a camera) of the mobile device. A size of the touchscreen may limit a number of the image filters displayable on-screen at any one time, such as during a particular display instance of the data content, and require an end-user to swipe and scroll through the data content to view, consider, and select any of the image filters existing off-screen during the display instance.

Accordingly, there is a need in the art for a method of displaying data content of a mobile device that overcomes the aforementioned problems associated with data content viewability, as such may be limited by sole display of the data content by a touchscreen of the mobile device.

Embodiments of the present invention are directed to a method, system, and computer program product for displaying and navigating data content of a mobile device.

In various embodiments, displaying the data content may include retrieving the data content, generating visualized data content based on and corresponding to the data content, and rendering the visualized data content for display by holographic projection. The holographically rendered data content may be displayed by a holographic projector with respect to on-screen data content displayed by a touchscreen of the mobile device. The holographically rendered data content may include off-screen data content corresponding to the on-screen data content displayed by the touchscreen (i.e., the data content that would otherwise exist off-screen of the touchscreen with respect to the on-screen data content). The holographically rendered data content may be displayed in space in positional alignment with the on-screen data content. The data content may be completely displayed in its entirety by the off-screen data content in combination with the on-screen data content.

In various embodiments, navigating the data content may include retrieving mobile device motion data, generating motion-adjusted visualized data content based on and corresponding to the data content and the mobile device motion data, and rendering the motion-adjusted visualized data content for display and navigation by holographic projection. The mobile device motion data may include translational and rotational motion data corresponding to translational and rotational motion of the mobile device in space, respectively. The holographically rendered motion-adjusted data content may be displayed by the holographic projector with respect to motion-adjusted on-screen data content displayed by the touchscreen. The holographically rendered motion-adjusted data content may include off-screen data content corresponding to the motion-adjusted on-screen data content displayed by the touchscreen. The displayed data content may be continuously adjusted and displayed based on the mobile device motion data to enable corresponding navigation of the data content based on the translational and/or rotational motion of the mobile device in space. The translational and/or rotational motion may be applied to move or shift off-screen data content on-screen for display by the touchscreen, and corresponding on-screen data content off-screen for display by the holographic projection. The off-screen data content that is shifted on-screen may subsequently be selected by way of the touchscreen. The translational and/or rotational motion may be applied to position and/or orient the mobile device relative to a position in space to which desired off-screen data content may be holographically projected in shifting the desired off-screen data content on-screen.

For purposes of the present disclosure, “visualized data content,” and/or “residual data content” may reference off-screen data content. The off-screen data content may be holographically displayed by a holographic projector with respect to on-screen data content as such may be displayed by a touchscreen of a mobile device. The off-screen data content and the on-screen data content may be displayed in association, simultaneously, and in synchrony during a display instance of the data content by the mobile device. The off-screen data content and the on-screen data content may be displayed by the holographic projector and the touchscreen, respectively. The off-screen data content may exist in association with the on-screen data content during the display instance as a result of screen size limitations of the touchscreen.

Advantageously, the present invention overcomes the aforementioned problems associated with the viewability of data content of a mobile device as such may be displayed by way of an associated touchscreen. In particular, the present invention enables the complete display of the data content in its entirety, allowing an end-user to view the data content in a single glance and reducing the amount of user inputs (e.g., gestures) that would otherwise be required to increase the efficiency of navigating, viewing, and selecting desired portions of the data content. To that end, the present invention may be implemented to increase the ergonomics and usability of a mobile device by increasing the extent of data content viewability on the mobile device beyond that which may be provided by the sole display of the data content by a touchscreen.

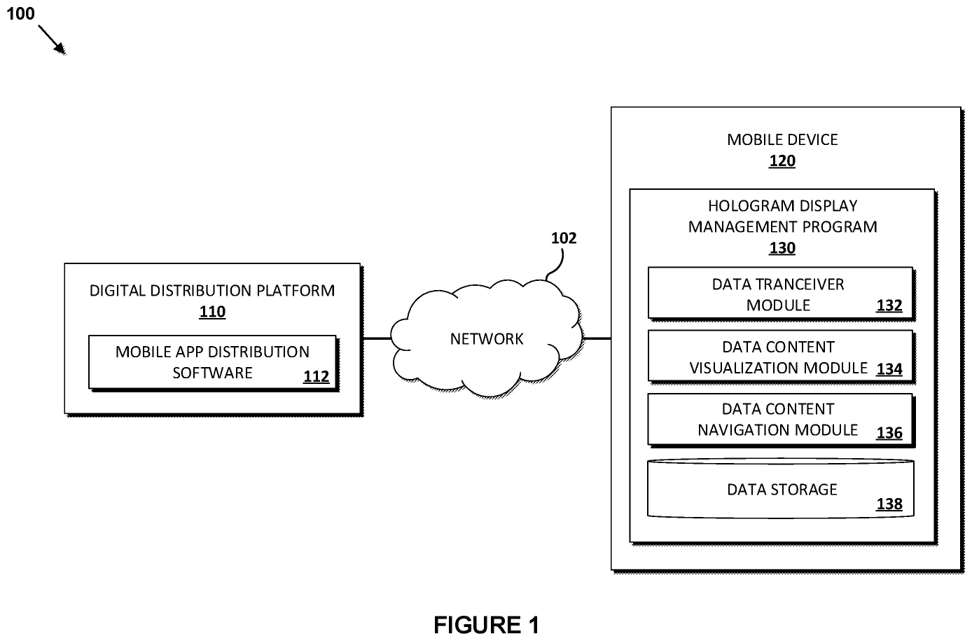

FIG. 1 is a functional block diagram depicting a data content display system 100, in accordance with an embodiment of the present invention. The data content display system 100 may include digital distribution platform 110 and mobile device 120 interconnected over network 102. While FIG. 1 depicts the data content display system 100 as including two discrete devices, other arrangements may be contemplated. For example, the data content display system 100 may include numerous devices such as digital distribution platform 110 and/or mobile device 120, which may be individually formed by one or more integrated or distinct devices

In various embodiments, network 102 may include, for example, an intranet, a local area network (LAN), a personal area network (PAN), a wireless local area network (WLAN), a wireless personal area network (WPAN), a wireless mesh network, a wide area network (WAN) such as the Internet, or the like. Network 102 may include wired, wireless, or fiber optic connections. Generally, network 102 may include any combination of connections and protocols for supporting communications between digital distribution platform 110 and mobile device 120, in accordance with embodiments of the present invention.

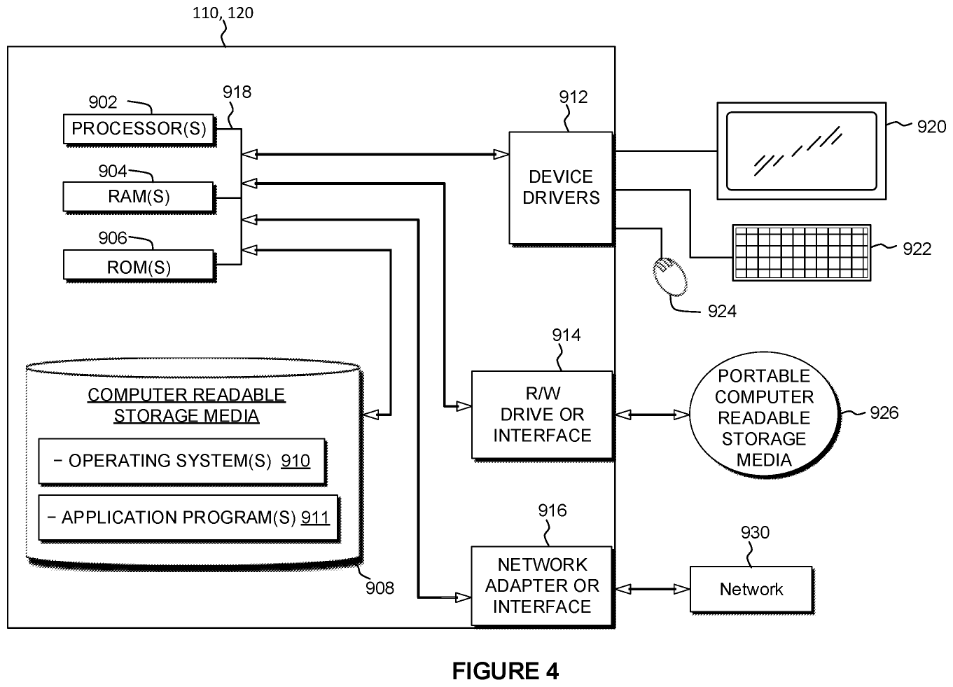

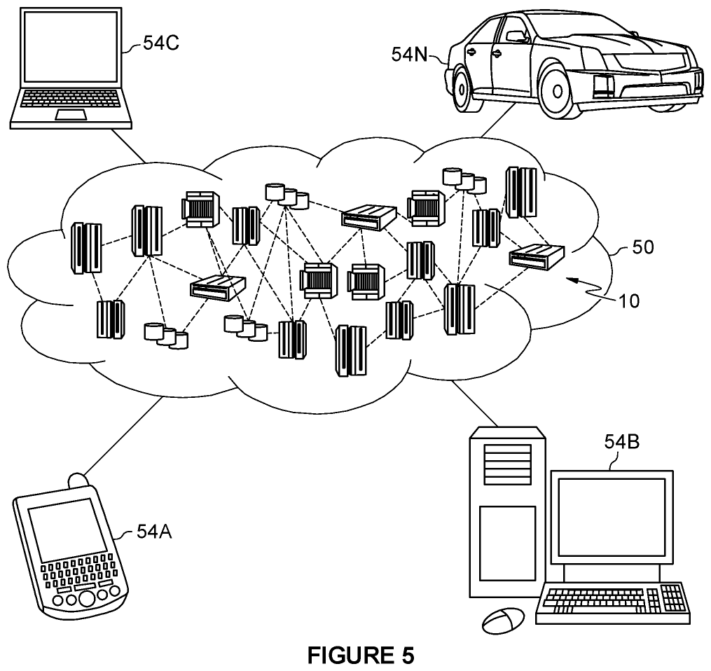

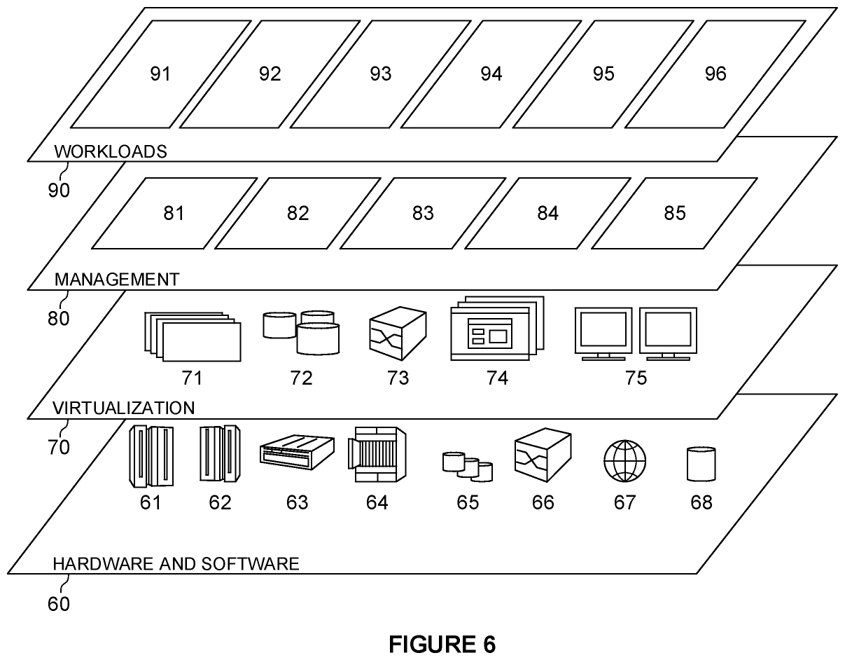

In various embodiments, digital distribution platform 110 and/or mobile device 120 may include a computing platform or node such as a wearable device, an implantable device, a mobile or smart phone, a tablet computer, a laptop computer, a desktop computer, a server such as a database server, a virtual machine, or the like. In the various embodiments, digital distribution platform 110 and/or mobile device 120 may otherwise include any other type of computing platform, computer system, or information system capable of sending and receiving data to and from another device, such as by way of network 102. In certain embodiments, digital distribution platform 110 and/or mobile device 120 may include internal and external hardware components, such as described with reference to FIG. 4. In other embodiments, digital distribution platform 110 and/or mobile device 120 may be implemented in or by way of a cloud computing environment, such as described with reference to FIGS. 5 and 6.

Digital distribution platform 110 hosts mobile app distribution software 112. Digital distribution platform 110 may implement a combination of devices and technologies such as network devices and device drivers to support the operation of mobile application 112, and provide a platform enabling communications between digital distribution platform 110 and mobile device 120, in accordance with embodiments of the present invention. As an example, digital distribution platform 110 may include a data hosting platform that may be implemented to support a web or Internet hosting service used for sharing, distributing, serving, or communicating data content associated with a photo- and video-sharing platform, a file and data sharing platform, a social networking platform, an email platform, or the like.

Mobile app distribution software 112 may include an application or program such as a software program, one or more subroutines contained in a program, an application programming interface, or the like. As an example, mobile app distribution software 112 may be implemented in sharing, distributing, serving, or communicating the data content of a photo- and video-sharing platform, a file and data sharing platform, a social networking platform, an email platform, or the like. The data content may be communicated, for example, to a target device such as mobile device 120 in response to receiving an associated data query.

In various embodiments, the data content may include, for example, data corresponding to a list, menu, table, or arrangement of data objects, data points, virtual objects, smart objects, and the like (“data objects”). A data object may represent and correspond to an end-user selectable item, such as an image filter that may be applied to edit an image. An arrangement of data objects may represent and correspond to an arrangement of end-user selectable items, such as a list or menu of image filters that may be applied to edit the image. In the various embodiments, the data content may include any type of displayable data corresponding to a list, menu, table, or arrangement of end-user selectable items, points, elements, or objects. In the various embodiments, the data content may otherwise include any type of displayable data corresponding to interactive information, media, and content, in accordance with embodiments of the present invention. The data objects may be displayed for navigation by way of a computing platform such as mobile device 120.

Mobile device 120 hosts hologram display management program 130. Mobile device 120 may implement a combination of devices and technologies such as network devices and device drivers to support the operation of hologram display management program 130, and provide a platform enabling communications between digital distribution platform 110 and mobile device 120, in accordance with embodiments of the present invention. As an example, mobile device 120 may include a mobile phone that may be implemented to communicate with the data hosting platform of digital distribution platform 110 to share, receive, and display data content associated with a photo- and video-sharing platform, a file and data sharing platform, a social networking platform, an email platform, or the like.

In an embodiment, mobile device 120 may include a touchscreen, a holographic projector, a translational motion sensor, and a rotational motion sensor.

In various embodiments, the touchscreen may be implemented in selecting displayed on-screen data content, in accordance with embodiments of the present invention. For example, the touchscreen may be implemented in selecting a displayed end-user selectable item of the displayed data content.

In various embodiments, the holographic projector may be implemented in rendering visualized data content for off-screen display (i.e., off-screen of the touchscreen) by holographic projection. The holographic projector may implement, for example, quantum photonic imaging to display the holographic projection such as with a resolution (i.e., pixel density) of approximately 5,000 pixels per inch (PPI) or more. As an example, the holographic projector may include a quantum photonic imaging chip including stacked layers of laser emitting diodes (LEDs). The holographic projector may be positioned with respect to mobile device 120 such as by way of attachment to a frame, bezel, or rim of mobile device 120. The holographic projector may be otherwise designed and implemented as a matter of design to display the holographic projection, in accordance with embodiments of the present invention.

The holographic projection may include holograms and holographic objects corresponding to holographically rendered data content. For example, a hologram may include a three-dimensional (3D) image formed by optical interference patterns composed of optical wavefronts of specific wavelength. The holographic projection may be displayed with respect to on-screen data content, as displayed by the touchscreen of mobile device 120. The holographic projection may include off-screen data content corresponding to the on-screen data content displayed by the touchscreen. The holographic projection may be displayed in space in positional alignment with the on-screen data content. For example, the holographic projection may include a hologram by which a 3D image corresponding to an arrangement of end-user selectable items may be displayed.

In various embodiments, the translational motion sensor may be implemented in generating mobile device motion data including translational or linear motion data corresponding to translational motion of mobile device 120 in space. In the various embodiments, motion-adjusted visualized data content may be generated based on the translational motion data. As an example, the translational motion sensor may include an accelerometer.

In various embodiments, the rotational motion sensor may be implemented in generating mobile device motion data including rotational motion data corresponding to rotational motion of mobile device 120 in space. In the various embodiments, motion-adjusted visualized data content may be generated based on the rotational motion data. As an example, the rotational motion sensor may include a gyroscope.

In various embodiments, the data content displayed by the touchscreen and the holographic projector may be continuously adjusted based on the mobile device motion data, to enable corresponding navigation of the displayed data content based on the translational and/or rotational motion of the mobile device in space. In the various embodiments, a relative position and orientation of mobile device 120 in space may be determined based on the translational motion data and the rotational motion data, respectively. In the various embodiments, the relative position and orientation of mobile device 120 may be determined during an associated display instance of data content, with respect to a corresponding position of a holographic projection in space.

Hologram display management program 130 includes data transceiver module 132, data content visualization module 134, data content navigation module 136, and data storage 138. Hologram display management program 130 may include an application or program such as a software program, one or more subroutines contained in a program, an application programming interface, or the like. Hologram display management program 130 communicates with the touchscreen, the holographic projector, the translational motion sensor, the rotational motion sensor, and one or more computer-readable RAMs, one or more computer-readable ROMs, and/or one or more computer readable storage media residing on mobile device 120. For purposes of the present disclosure, “mobile device storage” may reference the one or more computer-readable RAMs, one or more computer-readable ROMs, and/or one or more computer readable storage media residing on mobile device 120.

Data transceiver module 132 communicates with the mobile device storage residing on mobile device 120 to retrieve the shared and received data content (“shared data content”) by mobile device 120. Data transceiver module 132 further communicates with the translational and rotational motion sensors to retrieve the mobile device motion data. Data transceiver module 132 further communicates with the holographic projector to send and provide the visualized data content and the motion-adjusted visualized data content. Data transceiver module 132 stores the retrieved data in data storage 138 for later retrieval and use by hologram display management program 130.

Data content visualization module 134 generates the visualized data content and the motion-adjusted visualized data content for display by the touchscreen and holographic rendering by the holographic projector, accordingly. In various embodiments, the visualized data content and the motion-adjusted visualized data content may include on-screen data content for display by the touchscreen, and off-screen data content for display by the holographic projector. The generated visualized data content may include data corresponding to digital image rendering instructions such as for execution by the touchscreen, and hologram rendering instructions such as for execution by the holographic projector. The generated data may include the appropriate data types for proper digital image rendering and hologram rendering, respectively, in accordance with embodiments of the present invention. As an example, the data types may be chosen according to the specifications of the touchscreen and the holographic projector.

Data content navigation module 136 reconstructs and modulates the visualized data content, as generated by data content visualization module 134, to facilitate the generation of the motion-adjusted visualized data content to enable the data content navigation. Data content navigation module 136 further controls the selection of the data content based on the data content navigation. In various embodiments, the reconstructed and modulated visualized data content is implemented to continuously adjust the visualized data content for display by the touchscreen and the holographic projector, respectively, to enable navigation of the data content based on the translational and/or rotational motion of mobile device 120 in space. In the various embodiments, the continuously adjusted data content enables the navigation of the data content by allowing for movement of off-screen data content on-screen for display by the touchscreen, and corresponding on-screen data content off-screen for display by the holographic projection, based on and corresponding to a position and/or orientation of mobile device 120 relative to a position in space to which desired off-screen data content may be holographically projected.

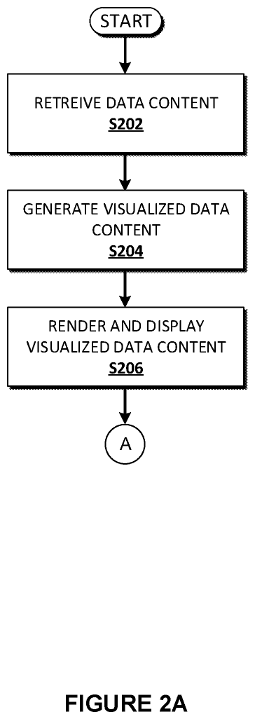

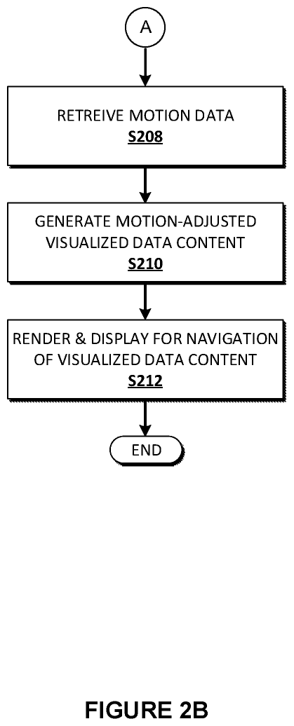

FIG. 2A is a flowchart depicting operational steps of an aspect of the data content display system 100, in accordance with an embodiment of the present invention.

At Step S202, data transceiver module 132 retrieves or otherwise detects the shared and received data content. In an embodiment, the shared data content may be retrieved in response to detecting receipt of the shared data content by mobile device 120, such as from digital distribution platform 110. In the embodiment, the shared data content may be retrieved in response to a determination that a total required display size of the shared data content exceeds a predetermined threshold. The predetermined threshold may be defined according to a screen size of the touchscreen of mobile device 120. For example, the total required display size may be determined based on an amount of data objects of the shared data content, above which the predetermined threshold may be exceeded.

At Step S204, data content visualization module 134 generates the visualized data content. In an embodiment, the visualized data content may be generated based on and corresponding to the retrieved data content for subsequent rendering and display by holographic projection. In the embodiment, the visualized data content may be generated to include off-screen data content corresponding to the on-screen data content displayed by the touchscreen during a display instance of the data content. In the embodiment, the visualized data content may include, for example, holographic visualization data content including hologram rendering instructions corresponding to the off-screen data content, wherein the off-screen data content includes the portion of the data content that is not displayable on-screen by the touchscreen during the display instance. The visualized data content may be generated by implementing a computer-generated holography (CGH) technique to generate a holographic interference pattern corresponding to the holographic projection.

For example, the CGH may include determining a virtual scattered wavefront corresponding to the holographic projection and encoding the virtual scattered wavefront for the subsequent rendering and display. Data content visualization module 134 may otherwise implement any other type of digital holography technique to generate the visualized data content for holographic rendering, in accordance with embodiments of the present invention.

At Step S206, the holographic projector renders the generated visualized data content for off-screen display by holographic projection. In an embodiment, the holographically rendered data content may be displayed with respect to on-screen data content displayed by the touchscreen during the display instance of the data content. In the embodiment, the holographically rendered data content may be displayed to include off-screen data content corresponding to the on-screen data content as displayed by the touchscreen during the display instance. In the embodiment, the data content may be holographically rendered based on the hologram rendering instructions. In the embodiment, the holographically rendered data content may include holographic off-screen data content for display by holographic projection in association with the on-screen data content. The holographic projector may be attached to mobile device 120, as previously described. Accordingly, the corresponding shared and received data content may be completely displayed in its entirety by the holographically displayed off-screen data content in combination with the on-screen data content as displayed by the touchscreen.

In an embodiment, the holographically rendered data content may be displayed in space in positional alignment with the on-screen data content. In the embodiment, the off-screen data content may be displayed simultaneously, in synchrony, and in conjunction with the on-screen data content. As an example, the holographically rendered data content may be displayed horizontally in space with respect to the on-screen data content, vertically in space with respect to the on-screen data content, or both horizontally and vertically in space with respect to the on-screen data content. The holographically rendered data content may be displayed, for example, based on a reference frame defined with respect to a two-dimensional (2D) plane of the touchscreen.

In an embodiment, a static user interface may be generated based on the displayed data content. In the embodiment, the static user interface may include, for example, the off-screen data content and the on-screen data content. The static user interface may be generated during the display instance of the data content for viewing, such as by an end-user of mobile device 120, the arrangement of data objects.

FIG. 2B is a flowchart depicting operational steps of an aspect of the data content display system 100, in accordance with an embodiment of the present invention.

At Step S208, data transceiver module 132 retrieves or otherwise detects the mobile device motion data. In an embodiment, the mobile device motion data may continuously be retrieved in response to detecting translational and/or rotational motion of mobile device 120. The mobile device motion data may include translational and/or rotational motion data corresponding to translational and rotational motion of mobile device 120 in space, respectively. In the embodiment, the translational motion may be detected based on translational motion data generated by the accelerometer of mobile device 120. In the embodiment, the rotational motion may be detected based on rotational motion data generated by the gyroscope of mobile device 120.

At Step 210, data content navigation module 136 generates the motion-adjusted visualized data content. In an embodiment, the motion-adjusted visualized data content may be generated based on and corresponding to the retrieved data content (as in Step S202) and the retrieved mobile device motion data (as in Step S208) for subsequent rendering and display by holographic projection. In the embodiment, the motion-adjusted visualized data content may be continuously generated to include motion-adjusted off-screen data content corresponding to the motion-adjusted on-screen data content displayed by the touchscreen during a sequence or series of display instances of the data content. The motion-adjusted visualized data content may be generated by reconstruction and modulation of the visualized data content, as generated by data content visualization module 134, to facilitate generation of the motion-adjusted visualized data content to enable the data content navigation.

For example, the reconstruction and modulation may be implemented to adjust the interference pattern corresponding to the holographic projection to adjust the spatial positioning of the holographically rendered data content with respect to the on-screen data content. In an embodiment, the reconstruction and modulation may be implemented based on the translational and/or rotational motion of mobile device 120 in space in accordance with the translational and/or rotational motion data corresponding to the translational and/or rotational motion of mobile device 120 in space, respectively. In an embodiment, the reconstruction and modulation may be implemented based on a position and/or an orientation of mobile device 120 in space.

At Step 212, the holographic projector renders the generated, motion-adjusted visualized data content for off-screen display by holographic projection. In an embodiment, the displayed data content may be continuously adjusted and displayed based on the mobile device motion data to enable corresponding navigation of the data content based on the translational and/or rotational motion of the mobile device in space. In the embodiment, motion-adjusted off-screen data content and motion-adjusted on-screen data content may be continuously rendered for synchronized and simultaneous display of the off-screen data content in conjunction with the motion-adjusted on-screen data content, as displayed by the holographic projector and the touchscreen, respectively. In the embodiment, the translational and/or rotational motion may be applied to move or shift off-screen data content on-screen for display by the touchscreen, and corresponding on-screen data content off-screen for display by the holographic projection during a sequence or series of display instances. In the embodiment, the off-screen data content that is shifted on-screen may subsequently be selected by way of the touchscreen. In the embodiment, the translational and/or rotational motion may be applied to position and/or orient the mobile device relative to a position in space to which desired off-screen data content may be holographically projected in shifting the desired off-screen data content on-screen. Accordingly, the corresponding shared and received data content may be completely and continuously displayed and adjusted in its entirety by the holographically displayed off-screen data content in combination with the on-screen data content as displayed by the touchscreen.

In an embodiment, a motion-adjusted user interface may be generated based on the displayed motion-adjusted data content. In the embodiment, the motion-adjusted user interface may include, for example, motion-adjusted off-screen data content and motion-adjusted on-screen data content. The motion-adjusted user interface may be generated during a sequence of display instances of the motion-adjusted data content for navigation, such as by the end-user of mobile device 120, the arrangement of data objects based on the mobile device motion data. In the embodiment, the navigation may include, for example,continuous adjustment of the displayed data objects based on the mobile device motion data to shift off-screen data content on-screen for display by the touchscreen and corresponding on-screen data content off-screen for display by the holographic projection.

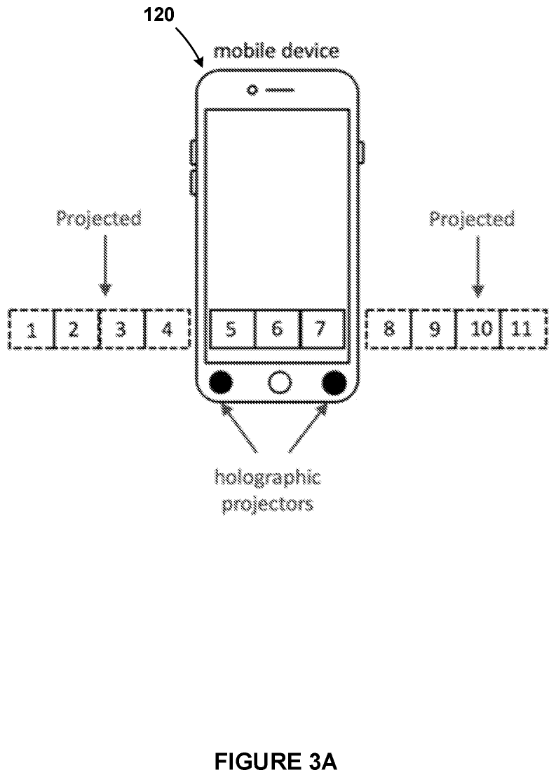

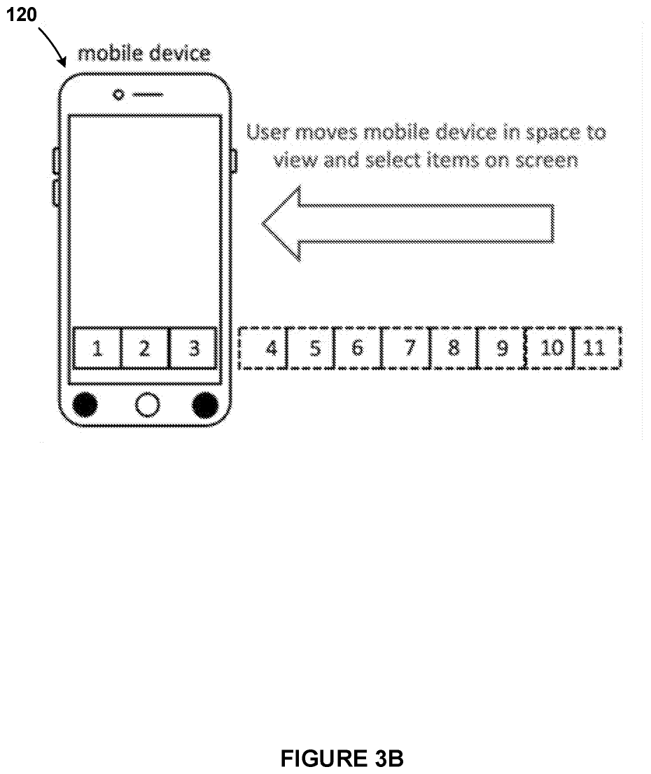

FIG. 3A is a flowchart depicting operational steps of an aspect of the data content display system 100, in accordance with an embodiment of the present invention.

As depicted in FIG. 3A, as the mobile device moves, the menu items projected and menu items shown on screen also move. So, if a user moves their device left, the menu items to the left of the device are now rendered on the mobile device screen, and the menu items that were previously rendered on the screen shuffle across to the right where they are projected holographically.

FIG. 3B is a flowchart depicting operational steps of an aspect of the data content display system 100, in accordance with an embodiment of the present invention.

As depicted in FIG. 3B, the user continues to move the mobile device until the intended menu item is shown on screen. The user then taps that menu item on the mobile device screen to select it.

In an embodiment, in addition to providing a 2D menu item selection, a three dimensional menu can be displayed whereby the user navigates menu items moving left right, forward and backwards.

FIG. 4 is a block diagram depicting digital distribution platform 110 and/or mobile device 120, in accordance with an embodiment of the present invention.

As depicted in FIG. 4, digital distribution platform 110 and/or mobile device 120 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. The network adapter 916 communicates with a network 930. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, such as secure password input program 130 residing on user device 120, as depicted in FIG. 1, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Digital distribution platform 110 and/or mobile device 120 may also include a R/W drive or interface 914 to read from and write to one or more portable computer readable storage media 926. Application programs 911 on digital distribution platform 110 and/or mobile device 120 may be stored on one or more of the portable computer readable storage media 926, read via the respective R/W drive or interface 914 and loaded into the respective computer readable storage media 908. Digital distribution platform 110 and/or mobile device 120 may also include a network adapter or interface 916, such as a Transmission Control Protocol (TCP)/Internet Protocol (IP) adapter card or wireless communication adapter (such as a 4G wireless communication adapter using Orthogonal Frequency Division Multiple Access (OFDMA) technology). Application programs 911 on the server 220 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers. Digital distribution platform 110 and/or mobile device 120 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may include hardware and software (stored on computer readable storage media 908 and/or ROM 906).

Digital distribution platform 110 and/or mobile device 120 can be a standalone network server, or represent functionality integrated into one or more network systems. In general, digital distribution platform 110 and/or mobile device 120 can be a laptop computer, desktop computer, specialized computer server, or any other computer system known in the art. In certain embodiments, digital distribution platform 110 and/or mobile device 120 represents computer systems utilizing clustered computers and components to act as a single pool of seamless resources when accessed through a network, such as a LAN, WAN, or a combination of the two. This implementation may be preferred for data centers and for cloud computing applications. In general, digital distribution platform 110 and/or mobile device 120 can be any programmable electronic device, or can be any combination of such devices.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and holographic display rendering 96. Holographic display rendering 96 may include functionality enabling the cloud computing environment to perform holographic display rendering, in accordance with embodiments of the present invention.

While the invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the present invention has been disclosed by way of example for purposes of illustration, and not limitation.

What is claimed is:

1. A computer-implemented method for holographically displaying and navigating data content of a mobile device comprising a touchscreen, the method comprising:
detecting data content comprising an arrangement of data objects, wherein the data content comprises on-screen data content and off-screen data content, wherein an amount of the data objects exceeds a predetermined threshold that is defined with respect to an amount of the on-screen data content displayable by the touchscreen during a display instance of the data content;
generating holographic visualization data content based on the data content, wherein the holographic visualization data content comprises hologram rendering instructions corresponding to the off-screen data content, wherein the off-screen data content comprises the portion of the data content that is not displayable on-screen by the touchscreen during the display instance,
rendering, by a holographic projector based on the hologram rendering instructions, a hologram comprising holographic off-screen data content for display by holographic projection in association with the on-screen data content;
displaying, by the holographic projector and the touchscreen, the off-screen data content and the on-screen data content, respectively, wherein the off-screen data content is displayed by way of the hologram and is displayed simultaneously, in synchrony, and in conjunction with the on-screen data content during the display instance; and
generating a static user interface based on the displayed data content, wherein the static user interface is generated during the display instance of the data content for viewing of the arrangement of data objects.

2. The computer-implemented method of claim 1, further comprising:
detecting mobile device motion data corresponding to motion of the mobile device in space;
generating motion-adjusted data content based on the data content and the mobile device motion data, wherein the motion-adjusted data content comprises motion-adjusted touchscreen display rendering instructions corresponding to the on-screen data content and motion-adjusted hologram rendering instructions corresponding to the off-screen data content, wherein the motion-adjusted data content is continuously generated based on the data content and the mobile device motion data;
rendering, by the holographic projector and the touchscreen, motion-adjusted off-screen data content and motion-adjusted on-screen data content, respectively, wherein the motion-adjusted data content is continuously rendered for synchronized and simultaneous display of the off-screen data content in conjunction with the motion-adjusted on-screen data content;
displaying, by the holographic projector and the touchscreen, the motion-adjusted off-screen data content and the motion-adjusted on-screen data content, respectively, wherein the motion-adjusted off-screen data content is displayed simultaneously, in synchrony, and in conjunction with the motion-adjusted on-screen data content, wherein the arrangement of data objects is displayed during a sequence of display instances of the motion-adjusted data content; and
generating a motion-adjusted user interface based on the displayed motion-adjusted data content, wherein the motion-adjusted user interface is generated during the sequence of display instances of the motion-adjusted data content for navigation of the arrangement of data objects based on the mobile device motion data, wherein the navigation comprises continuous adjustment of the displayed data objects based on the mobile device motion data to shift off-screen data content on-screen for display by the touchscreen and corresponding on-screen data content off-screen for display by the holographic projection, wherein the navigation comprises two-dimensional navigation of the displayed data objects, wherein the navigation further comprises three-dimensional navigation of the displayed data objects.

3. The computer-implemented method of claim 1, wherein the predetermined threshold is defined based on a display size of the touchscreen.

4. The computer-implemented method of claim 1, wherein the holographic projector is attached to a bezel of the mobile device.

5. The computer-implemented method of claim 1, wherein the off-screen data content is displayed in spatial alignment with the on-screen data content.

6. The computer-implemented method of claim 2, wherein the motion-adjusted off-screen data content is displayed in spatial alignment with the motion-adjusted on-screen data content.

7. The computer-implemented method of claim 2, wherein the mobile device motion data comprises one or more of translational motion data and rotational motion data.

8. A computer system for holographically displaying and navigating data content of a mobile device comprising a touchscreen, the computer system comprising:
one or more computer processors, one or more computer-readable storage media, and program instructions stored on one or more of the computer-readable storage media for execution by at least one of the one or more computer processors, the program instructions, when executed by the at least one of the one or more computer processors, causing the computer system to perform a method comprising:
detecting data content comprising an arrangement of data objects, wherein the data content comprises on-screen data content and off-screen data content, wherein an amount of the data objects exceeds a predetermined threshold that is defined with respect to an amount of the on-screen data content displayable by the touchscreen during a display instance of the data content;
generating holographic visualization data content based on the data content, wherein the holographic visualization data content comprises hologram rendering instructions corresponding to the off-screen data content, wherein the off-screen data content comprises the portion of the data content that is not displayable on-screen by the touchscreen during the display instance,
rendering, by a holographic projector based on the hologram rendering instructions, a hologram comprising holographic off-screen data content for display by holographic projection in association with the on-screen data content;
displaying, by the holographic projector and the touchscreen, the off-screen data content and the on-screen data content, respectively, wherein the off-screen data content is displayed by way of the hologram and is displayed simultaneously, in synchrony, and in conjunction with the on-screen data content during the display instance; and
generating a static user interface based on the displayed data content, wherein the static user interface is generated during the display instance of the data content for viewing of the arrangement of data objects.

9. The computer system of claim 8, the method further comprising:
detecting mobile device motion data corresponding to motion of the mobile device in space;
generating motion-adjusted data content based on the data content and the mobile device motion data, wherein the motion-adjusted data content comprises motion-adjusted touchscreen display rendering instructions corresponding to the on-screen data content and motion-adjusted hologram rendering instructions corresponding to the off-screen data content, wherein the motion-adjusted data content is continuously generated based on the data content and the mobile device motion data;
rendering, by the holographic projector and the touchscreen, motion-adjusted off-screen data content and motion-adjusted on-screen data content, respectively, wherein the motion-adjusted data content is continuously rendered for synchronized and simultaneous display of the off-screen data content in conjunction with the motion-adjusted on-screen data content;
displaying, by the holographic projector and the touchscreen, the motion-adjusted off-screen data content and the motion-adjusted on-screen data content, respectively, wherein the motion-adjusted off-screen data content is displayed simultaneously, in synchrony, and in conjunction with the motion-adjusted on-screen data content, wherein the arrangement of data objects is displayed during a sequence of display instances of the motion-adjusted data content; and
generating a motion-adjusted user interface based on the displayed motion-adjusted data content, wherein the motion-adjusted user interface is generated during the sequence of display instances of the motion-adjusted data content for navigation of the arrangement of data objects based on the mobile device motion data, wherein the navigation comprises continuous adjustment of the displayed data objects based on the mobile device motion data to shift off-screen data content on-screen for display by the touchscreen and corresponding on-screen data content off-screen for display by the holographic projection, wherein the navigation comprises two-dimensional navigation of the displayed data objects, wherein the navigation further comprises three-dimensional navigation of the displayed data objects.

10. The computer system of claim 8, wherein the predetermined threshold is defined based on a display size of the touchscreen.

11. The computer system of claim 8, wherein the holographic projector is attached to a bezel of the mobile device.

12. The computer system of claim 8, wherein the off-screen data content is displayed in spatial alignment with the on-screen data content

13. The computer system of claim 9, wherein the motion-adjusted off-screen data content is displayed in spatial alignment with the motion-adjusted on-screen data content.

14. The computer system of claim 9, wherein the mobile device motion data comprises one or more of translational motion data and rotational motion data.

15. A computer program product for holographically displaying and navigating data content of a mobile device comprising a touchscreen, the computer program product comprising:
one or more computer-readable storage devices and program instructions stored on at least one of the one or more computer-readable storage devices for execution by at least one or more computer processors of a computer system, the program instructions, when executed by the at least one of the one or more computer processors, causing the computer system to perform a method comprising:
detecting data content comprising an arrangement of data objects, wherein the data content comprises on-screen data content and off-screen data content, wherein an amount of the data objects exceeds a predetermined threshold that is defined with respect to an amount of the on-screen data content displayable by the touchscreen during a display instance of the data content;
generating holographic visualization data content based on the data content, wherein the holographic visualization data content comprises hologram rendering instructions corresponding to the off-screen data content, wherein the off-screen data content comprises the portion of the data content that is not displayable on-screen by the touchscreen during the display instance,
rendering, by a holographic projector based on the hologram rendering instructions, a hologram comprising holographic off-screen data content for display by holographic projection in association with the on-screen data content;
displaying, by the holographic projector and the touchscreen, the off-screen data content and the on-screen data content, respectively, wherein the off-screen data content is displayed by way of the hologram and is displayed simultaneously, in synchrony, and in conjunction with the on-screen data content during the display instance; and
generating a static user interface based on the displayed data content, wherein the static user interface is generated during the display instance of the data content for viewing of the arrangement of data objects.

16. The computer program product of claim 15, the method further comprising:
detecting mobile device motion data corresponding to motion of the mobile device in space, wherein the mobile device motion data comprises one or more of translational motion data and rotational motion data;
generating motion-adjusted data content based on the data content and the mobile device motion data, wherein the motion-adjusted data content comprises motion-adjusted touchscreen display rendering instructions corresponding to the on-screen data content and motion-adjusted hologram rendering instructions corresponding to the off-screen data content, wherein the motion-adjusted data content is continuously generated based on the data content and the mobile device motion data;
rendering, by the holographic projector and the touchscreen, motion-adjusted off-screen data content and motion-adjusted on-screen data content, respectively, wherein the motion-adjusted data content is continuously rendered for synchronized and simultaneous display of the off-screen data content in conjunction with the motion-adjusted on-screen data content;
displaying, by the holographic projector and the touchscreen, the motion-adjusted off-screen data content and the motion-adjusted on-screen data content, respectively, wherein the motion-adjusted off-screen data content is displayed simultaneously, in synchrony, and in conjunction with the motion-adjusted on-screen data content, wherein the arrangement of data objects is displayed during a sequence of display instances of the motion-adjusted data content; and
generating a motion-adjusted user interface based on the displayed motion-adjusted data content, wherein the motion-adjusted user interface is generated during the sequence of display instances of the motion-adjusted data content for navigation of the arrangement of data objects based on the mobile device motion data, wherein the navigation comprises continuous adjustment of the displayed data objects based on the mobile device motion data to shift off-screen data content on-screen for display by the touchscreen and corresponding on-screen data content off-screen for display by the holographic projection, wherein the navigation comprises two-dimensional navigation of the displayed data objects, wherein the navigation further comprises three-dimensional navigation of the displayed data objects.

17. The computer program product of claim 15, wherein the predetermined threshold is defined based on a display size of the touchscreen.

18. The computer program product of claim 15, wherein the holographic projector is attached to a bezel of the mobile device

19. The computer program product of claim 15, wherein the off-screen data content is displayed in spatial alignment with the on-screen data content.

20. computer program product of claim 16, wherein the motion-adjusted off-screen data content is displayed in spatial alignment with the motion-adjusted on-screen data content.
